(19) United States
(12) Patent Application Publication
(10) Pub. No.: US 2026/0141463 A1
(43) Pub. Date: May 21, 2026

(54) SYSTEMS AND METHODS FOR ELECTRICAL ENERGY-BASED TRANSACTIONS

(71) Applicant: Mastercard International Incorporated, Purchase, NY (US)

(72) Inventors: Shawn Mehrhoff, Sappington, MO (US); Christopher T. Scholl, Manchester, MO (US); David Vorhies, Saint Charles, MO (US)

(73) Assignee: Mastercard International Incorporated, Purchase, NY (US)

(21) Appl. No.: 18/952,690

(22) Filed: Nov. 19, 2024

(51) Int. Cl. G06Q 50/06; F24F 11/46; G06Q 20/36

(52) U.S. Cl. CPC G06Q 50/06; F24F 11/46; G06Q 20/363

(57) ABSTRACT

A computing system includes one or more processors and a memory. The computing system is configured to register a consumer for an energy or resource reduction service. The system monitors electrical power usage at a property associated with the consumer and adjusts an HVAC system at the property based on the consumer’s geo-location data. The system determines an energy savings amount resulting from the HVAC system adjustment and associates a monetary value with the energy savings at the property. The system transmits the monetary value to a digital wallet application associated with the consumer.

### BACKGROUND

The field of the disclosure relates generally to electronic payment systems for vehicle charging transactions and, more specifically, to electronic payment systems for processing electrical energy-based transactions between a cardholder and a merchant.

The increasing demand for energy, coupled with the global shift towards sustainability, has led utility companies to explore ways to optimize energy consumption, particularly in residential settings. Consumers are increasingly seeking methods to reduce their energy usage, driven by both economic and environmental considerations. Utility companies have responded by implementing programs that enable adjustments to consumers’ energy consumption, especially during peak usage periods or when grid stability is at risk. These adjustments can help lower energy consumption, but existing programs often do not provide tangible, immediate benefits to consumers beyond minimal cost savings on their utility bills.

Simultaneously, the growing adoption of electric vehicles (EVs) introduces new challenges, particularly related to the cost and accessibility of charging infrastructure. Frequent charging is necessary to maintain an EV’s usability, but it also imposes financial burdens on consumers, who are looking for more cost-effective ways to charge their vehicles. There is currently no seamless mechanism to bridge the gap between a consumer’s efforts to reduce energy consumption at their home and the financial demands of charging their EVs. While many consumers participate in energy-saving programs, the direct incentives for reducing residential energy usage, particularly in relation to EV charging, remain limited.

### BRIEF DESCRIPTION

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, a system is provided. The system includes a utility company computing system having one or more processors and a memory. The memory includes instructions that when executed by the one or more processors, cause the one or more processors to register a consumer for an energy or resource reduction service. The processors monitor electrical power usage at a property associated with the consumer and adjust an HVAC system at the property based on geo-location data of the consumer. The processors determine an energy savings amount based on the adjustment to the HVAC system and associate a monetary value with energy savings at the property. Furthermore, the processors transmit the monetary value to a digital wallet application associated with the consumer.

In another aspect, a method is provided. The method includes registering a consumer for an energy or resource reduction service. The method also includes monitoring electrical power usage at a property associated with the consumer. The method furthermore includes adjusting an HVAC system at the property based on geo-location data of the consumer. The method includes determining an energy savings amount based on the adjustment to the HVAC system. In addition, the method includes associating a monetary value with energy savings at the property. Moreover, the method includes transmitting the monetary value to a digital wallet application associated with the consumer.

A variety of additional aspects will be set forth in the detailed description that follows. These aspects can relate to individual features and to combinations of features. The advantages of these and other aspects will be apparent to those skilled in the art from the following description of the exemplary embodiments which have been shown and described by way of illustration. As will be realized, the details of the present aspects described herein may be modified in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a block diagram depicting an exemplary multiparty payment card processing system and network for processing payment transaction, including vehicle charging payment transactions, in accordance with an aspect of the present disclosure;

FIG. 2 is an example configuration of a computing system for use with the system of FIG. 1;

FIG. 3 is an example configuration of a server system for use with the system of FIG. 1; and

FIG. 4 is a process flow diagram of a process for an electrical energy-based transaction between a consumer and a charging supplier merchant, in accordance with an aspect of the present disclosure.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein.

### DETAILED DESCRIPTION OF THE DISCLOSURE

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized and changes may be made without departing from the scope of the claims. The following description is, therefore, not limiting. It is contemplated that the invention has general application to charging electric vehicles. The scope of the present invention is defined only by the appended claims, along with the full scope of equivalents to which such claims are entitled.

### EXAMPLE SYSTEM

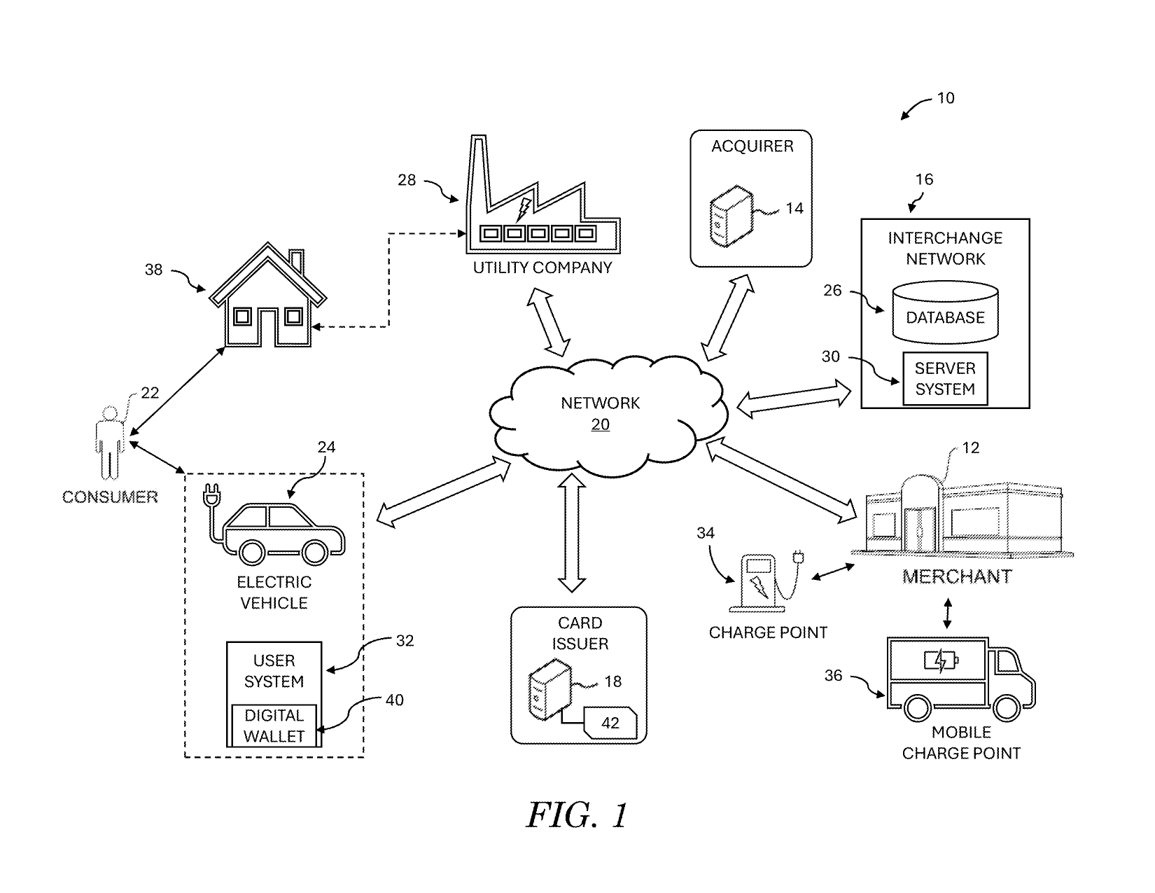

FIG. 1 is a block diagram depicting an exemplary multiparty payment card processing system and network 10 for processing payment transactions, including vehicle charging payment transactions. Embodiments described herein may relate to a transaction card system, such as a credit card payment system using the Mastercard^{®} interchange network. (Mastercard is a registered trademark of Mastercard International Incorporated.) The Mastercard interchange network is a set of proprietary communications standards promulgated by Mastercard International Incorporated for the exchange of financial transaction data and the settlement of funds between financial institutions that are members of the Mastercard interchange network. Embodiments described herein may also relate to digital payment services such as “Click to Pay,” a unified digital payments service offered by Mastercard, or another digital wallet service for a mobile device such as a smartphone.

In the exemplary embodiment, the system 10 facilitates providing interchange network services offered by an interchange network 16. In addition, the system 10 enables payment card transactions in which merchants, such as a merchant 12 and utility company 28, an acquirer 14, and/or a card issuer 18 do not need to have a one-to-one relationship. Although parts of the system 10 are presented in one arrangement, other embodiments may include the same or different parts arranged otherwise, depending, for example, on authorization processes for purchase transactions, communication between computing devices, etc.

In the example embodiment, the merchant 12, the utility company 28, the acquirer 14, the interchange network 16, and the issuer 18 may be coupled together in communication via a network 20. The network 20 may include, for example and without limitation, one or more of a local area network (LAN), a wide area network (WAN) (e.g., the Internet, etc.), a mobile network, a virtual network, and/or any other suitable public and/or private network capable of facilitating communication among the merchant 12, utility company 28, the acquirer 14, the interchange network 16, and/or the issuer 18. In some embodiments, the network 20 may include more than one type of network, such as a private payment transaction network provided by the interchange network 16 to the acquirer 14 and the issuer 18 and, separately, the public Internet, which may facilitate communication between the merchant 12, the utility company 28, the interchange network 16, the acquirer 14, and a consumer 22 (also referred to as a “cardholder” or “user”), etc.

In the example system 10, a financial institution called the “issuer,” such as the issuer 18, issues a transaction card, such as a credit card account or a debit card account, to the consumer 22, who uses the transaction card to tender payment for a purchase from a merchant, such as the merchant 12 and/or the utility company 28. The consumer 22 may input information from the transaction card into a user system 32 and store the information in a digital wallet 40. The information may be stored as digital wallet data (broadly, payment credentials). The merchant 12 and/or the utility company 28 is typically associated with goods and/or services offered for sale and sold to the consumer 22. In particular, the merchant 12 may be associated with operating a charge point 34 and/or mobile charger point 36 that are configured to provide electrical energy to electric vehicles, such as an electric vehicle 24. The merchant 12 includes, for example, a physical location and/or a virtual location such as an Internet-based storefront. The utility company 28, such as an electric company or other grid operator that oversees the power grid (either a macro-grid or micro-grid), a water company, a gas company, etc., may be associated with supplying utility services, such as electric power, water, gas, etc., to a property 38 belonging to, or otherwise associated with, the consumer 22.

To accept payment from the consumer 22, for example, with the digital wallet data stored in the digital wallet 40, the merchant 12 and/or the utility company 28 must normally establish an account with a financial institution that is part of the system 10. This financial institution is usually called the “merchant bank,” the “acquiring bank,” or the acquirer 14. When the consumer 22 submits payment for a purchase with the user system 32 using the digital wallet 40, for example, the merchant 12 and/or the utility company 28 requests authorization from the acquirer 14 for the purchase. The request may be performed over a telephone but is usually performed using a point-of-sale (POS) terminal that reads the consumer’s account information from a magnetic stripe, a chip, embossed characters on the transaction card, or digital wallet data. The POS terminal communicates electronically with the transaction processing computers of the acquirer 14. Alternatively, the acquirer 14 may authorize a third party to perform transaction processing on its behalf. In this case, the point-of-sale terminal will be configured to communicate with the third party. Such a third party is usually called a “merchant processor,” an “acquiring processor,” or a “third party processor.”

Using the interchange network 16, the computers of the acquirer 14 or the merchant processor will communicate with computers of the issuer 18 to determine whether the consumer’s account is in good standing and whether the purchase is covered by the consumer’s available credit line or account balance. Based on these determinations, the request for authorization will be declined or accepted. If the request is accepted, a bank network reference number, an authorization code, and/or other transaction identifier(s) that may be used to identify the transaction is issued to the merchant 12 and/or the utility company 28.

The interchange network 16 may be configured to process authorization messages, such as ISO^{®} 8583 compliant messages and ISO^{®} 20022 compliant messages. As used herein, “ISO^{®}” includes a series of standards approved by the International Organization for Standardization (ISO is a registered trademark of the International Organization for Standardization of Geneva, Switzerland). ISO 8583 compliant messages are defined by the ISO 8583 standard that governs financial transaction card originated messages and further defines acceptable message types, data elements, and code values associated with such financial transaction card originated messages. ISO 8583 compliant messages include a plurality of specified locations for data elements. ISO 20022 compliant messages are defined by the ISO 20022 standard. For example, ISO 20022 compliant messages may include acceptor to issuer card messages (ATICA).

During the authorization process of the system 10, a clearing process is also taking place. During the clearing process, the acquirer 14 provides the issuer 18 with information relating to the sale. No money is exchanged during clearing. Clearing (also referred to as “first presentment”) involves the exchange of data required to identify the consumer account 42, such as the account number, expiration date, billing address, amount of the sale, and/or other transaction identifiers that may be used to identify the transaction. Along with this data, banks in the United States also include a bank network reference number, such as a Banknet Reference Number used by Mastercard, which identifies the specific transaction. When the issuer 18 receives this data, the issuer 18 posts the amount of sale as a draw against the available credit in the consumer account 42 and prepares to send payment to the acquirer 14.

When a request for authorization is accepted, the available credit line of the consumer’s account 42 is decreased. Normally, a charge for a payment card transaction is not posted immediately to the consumer’s account 42 because bankcard associations, such as Mastercard, have promulgated rules that do not allow the merchant 12 and/or the utility company 28 to charge, or “capture,” a transaction until the purchased goods are shipped or the purchased services are delivered. However, with respect to at least some debit card transactions, a charge may be posted at the time of the transaction. When the merchant 12 and/or the utility company 28 ships or delivers the goods or services, the merchant 12 and/or the utility company 28 captures the transaction by, for example, appropriate data entry procedures on a point-of-sale terminal. This may include bundling of approved transactions daily for standard retail purchases. If the consumer 22 cancels a transaction before it is captured, a “void” is generated. If the consumer 22 returns goods after the transaction has been captured, a “credit” is generated. The interchange network 16 and/or the issuer 18 stores the payment card information, such as, and without limitation, a type of merchant, a merchant identifier, a location where the transaction was completed, an amount of purchase, and a date and time of the transaction, in a database 26.

After a transaction is authorized and cleared, the transaction is settled among the merchant 12 and/or the utility company 28, the acquirer 14, and the issuer 18. Settlement refers to the transfer of financial data or funds among the merchant 12 and/or the utility company 28, the acquirer 14, and the issuer 18 related to the transaction. In some embodiments, transactions are captured and accumulated into a “batch,” which is settled as a group. In other embodiments, the transactions are captured and settled individually or in a group in substantially real-time. More specifically, a transaction is typically settled between the issuer 18 and the interchange network 16, and then between the interchange network 16 and the acquirer 14, and then between the acquirer 14 and the merchant 12 and/or the utility company 28.

In some embodiments, the payment card transaction is a card present transaction conducted, for example, by swiping or dipping a payment card at the merchant’s point-of-sale (POS) terminal. Alternatively, the payment card transaction may be a card-not-present transaction conducted, for example, with a payment card stored on file with the merchant 12 and/or the utility company 28, or stored as digital wallet data in the digital wallet 40 on a consumer’s computing device, such as the user system 32. In some embodiments, the user system 32 and the digital wallet 40 may be integrated with the electric vehicle 24.

The user system 32 may be, for example, a computing device integrated with the electric vehicle 24, a cellular telephone, a smart watch or other electronic wearable apparel, a tablet, an implanted smart device, a personal computing device, or any other electronic device capable of two-way digital communications which may be associated with a consumer. In some embodiments, the user system 32 may be replaced with another computing device suitable for performing the functions disclosed herein (e.g., a desktop or laptop computer, a smart television, etc.).

The user system 32 may additionally be configured to assist the consumer 22 with setting up an account with the interchange network 16. During the account setup process, the consumer 22 may transmit account registration information to the interchange network 16, via the user system 32. The account registration information may include, for example, and without limitation, payment account data (e.g., a primary account number (PAN), a virtual payment number, limited use number, etc.) and user system identification data (e.g., a vehicle identification number (VIN), Electronic Serial Number (ESN), Mobile Equipment Identifier (MEID), International Mobile Equipment Identity (IMEI) number, and the like). For example, the interchange network 16 may receive account registration information from the user system 32 identifying the user system 32 and a payment account or PAN associated with the consumer 22. The consumer 22 may, for example, set up the account with the interchange network 16 by providing the account registration information and generating a login identifier (i.e., a UserID) and a password used when logging into an application for communicating with the interchange network 16. The consumer 22 may transmit various information or data to the interchange network 16 via an application, which may be stored on, partially stored on, or accessed via a web-browser of the user device 32. The information or data transmitted by the consumer 22 to the interchange network 16 may also include, for example, authentication information associated with the consumer’s PAN, biometrics of the consumer, and/or contact information. The contact information may include one or more ways to communicate with the consumer 22, including, for example, via a push notification associated with the application, a short messaging service (SMS) message, an email message, a telephone number, and the like. The interchange network 16 may generate a new account profile or update an existing account profile for the account associated with the account registration information received from the user system 32. Payment information associated with the account is stored in the digital wallet 40.

In the example embodiment, the interchange network 16 includes a server system 30 coupled in communication with the merchant 12 and associated charger points 34 and 36, the acquirer 14, and the issuer 18. The server system 30 is also coupled in communication with a one or more client systems, such as the user system 32 and other user systems. In one embodiment, the user system 32 constitutes computers including a web browser, such that the server system 30 is accessible to the user system 32 using the Internet. The user system 32 is interconnected to the Internet through one or more interfaces including, for example, a network, such as a LAN or WAN, dial-in-connections, cable modems, and/or special high-speed Integrated Services Digital Network (ISDN) lines. The user system 32 can be any device capable of interconnecting to the Internet including an Internet connected phone, a PDA, or any other suitable web-based connectable equipment.

The one or more charge points (CPs) 34 and 36 may be connected to the merchant 12 and to the server system 30. The CPs 34 and 36 may be interconnected to the Internet (or any other network that allows the CPs 34 and 36 to communicate as described herein) through any one or more suitable interfaces including a network, such as a local area network (LAN) or a wide area network (WAN), dial-in-connections, cable modems, wireless modems, and special high-speed ISDN lines. The CPs 34 and 36 are any device capable of interconnecting to the Internet and including an input device capable of reading information received from the digital wallet 40 of the user system 32.

In the example embodiment, the server system 30 is connected to the database 26, which is configured to store information on a variety of matters, including account information associated with consumers. In one embodiment, the database 26 is a centralized database stored on the server system 30. In an alternative embodiment, the database 26 is stored remotely from the server system 30 and may be a distributed or non-centralized database. In an embodiment, the database 26 may include a single database having separated sections or partitions or may include multiple databases, each being separate from each other. The database 26 may store transaction data generated as part of sales activities and savings activities conducted over the processing network including data relating to merchants, account holders or customers, issuers, acquirers, savings amounts, savings account information, and/or purchases made. The database 26 may also store account data including at least one of a consumer name, a consumer address, an account number, and other account identifier. The database 26 may also store merchant data including a merchant identifier that identifies each merchant registered to use the network, and instructions for settling transactions including merchant bank account information. The database 26 may also store purchase data associated with items being purchased by a consumer from a merchant, and authorization request data. The database 26 may also store device information, payment card information, and other data involved with processing transactions between one or more parties.

It is noted that the system 10 may include more, fewer, or alternative components and/or perform more, fewer, or alternative actions, including those discussed elsewhere herein.

### EXEMPLARY COMPUTER SYSTEMS

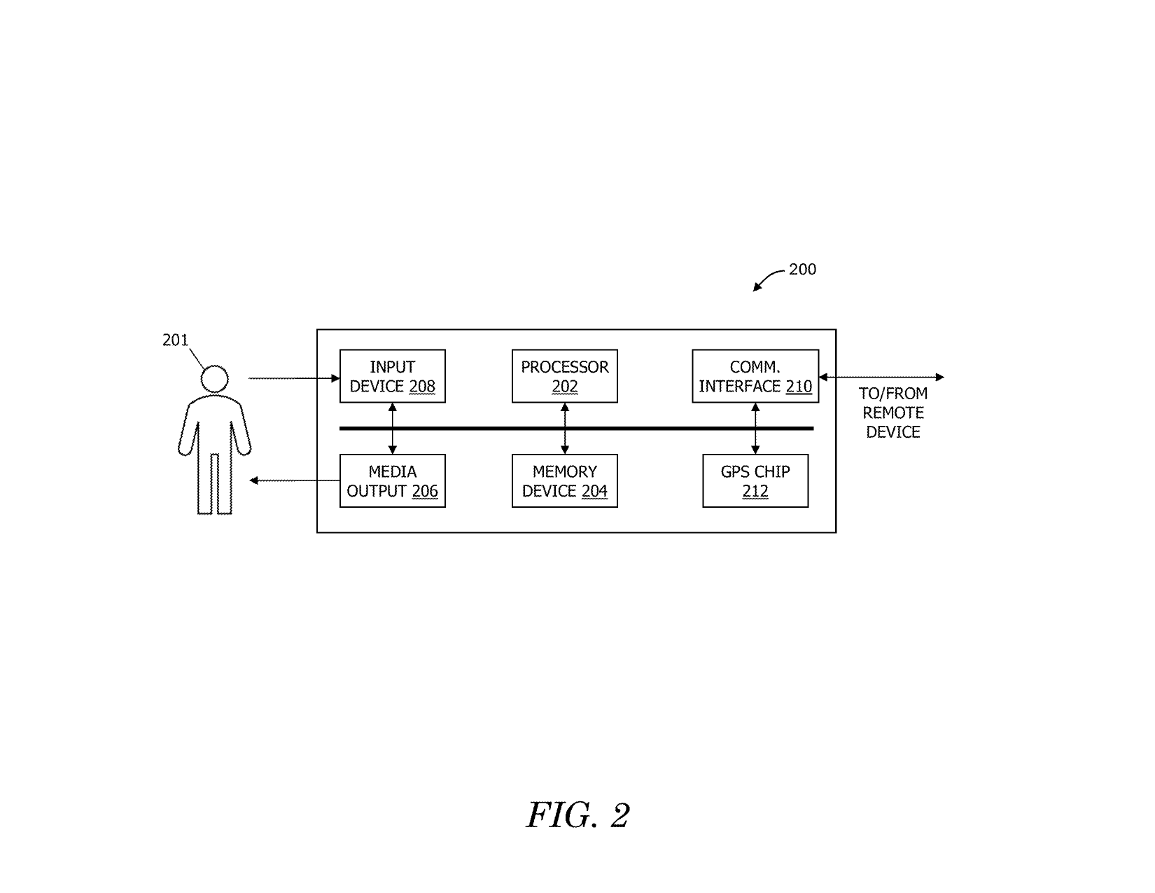

FIG. 2 is an example configuration of a computing system 200. In some embodiments, the computing system 200 is a user system 32 (shown in FIG. 1) operated by a user 201, such as the consumer 22 (shown in FIG. 1). The computer system 200 may also be a computing system integrated with the CPs 34 and 36. In some embodiments, the computing system 200 is integrated with the electric vehicle 24 (shown in FIG. 1).

In the example, the computing system 200 includes a processor 202 for executing instructions. In some embodiments, executable instructions are stored in a memory device 204. The processor 202 includes one or more processing units, for example, defining a multi-core configuration. The memory device 204 is any device allowing information such as digital wallet data, executable instructions, and the like to be stored thereon and retrieved therefrom. The memory device 204 includes one or more computer readable media.

In some embodiments, the computing system 200 includes a GPS chip 212. A location of the computing system 200 can be obtained through conventional methods, such as a location service (e.g., global positioning system (GPS) service) in the computing system 200, “ping” data that includes geotemporal data, from cell location register information held by a telecommunications provider to which the computing system 200 is connected, and the like. In various embodiments, the GPS chip 212 can be part of or separate from the processor 202 to enable the location of the computing system 200 to be determined.

The computing system 200 also includes at least one media output component 206 for presenting information to the user 201. The media output component 206 is any component capable of conveying information to the user 201. In some embodiments, the media output component 206 includes an output adapter such as a video adapter and/or an audio adapter. An output adapter is operatively coupled to the processor 202 and operatively connectable to an output device such as a display device, a liquid crystal display (LCD), organic light emitting diode (OLED) display, or “electronic ink” display, or an audio output device, a speaker, or headphones.

In some embodiments, the computing system 200 includes an input device 208 for receiving input from the user 201. The input device 208 may include, for example, a touch sensitive panel, a touch pad, a touch screen, a stylus, a gyroscope, an accelerometer, a position detector, a keyboard, a pointing device, a mouse, or an audio input device. A single component, such as a touch screen, may function as both an output device of the media output component 206 and the input device 208.

The computing system 200 may also include a communication interface 210, which is communicatively connectable to a remote computing device, such as the server system 30 (shown in FIG. 1), the electric vehicle 24 (shown in FIG. 1) and/or the CPs 34 and 36 (shown in FIG. 1). The communication interface 210 may include, for example, a wired or wireless network adapter or a wireless data transceiver for use with Bluetooth communication, radio frequency communication, near field communication (NFC); and/or with a mobile phone network, such as Global System for Mobile communications (GSM), 3G, 4G, 5G, or other mobile data network; and/or Worldwide Interoperability for Microwave Access (WiMax) and the like.

Stored in the memory device 204 are, for example, computer readable instructions for providing a user interface to the user 201 via the media output component 206 and, optionally, receiving and processing input from the input device 208. A user interface may include, among other possibilities, a web browser and a client application. Web browsers enable users, such as the user 201, to display and interact with media and other information typically embedded on a web page or a website from the server system 30. A client application allows the user 201 to interact with, for example, a server application from the server system 30 and/or an interface from the CPs 34 and 36. In the example embodiment, the memory device 204 may store digital wallet data corresponding to a digital wallet, such as the digital wallet 40 (shown in FIG. 1).

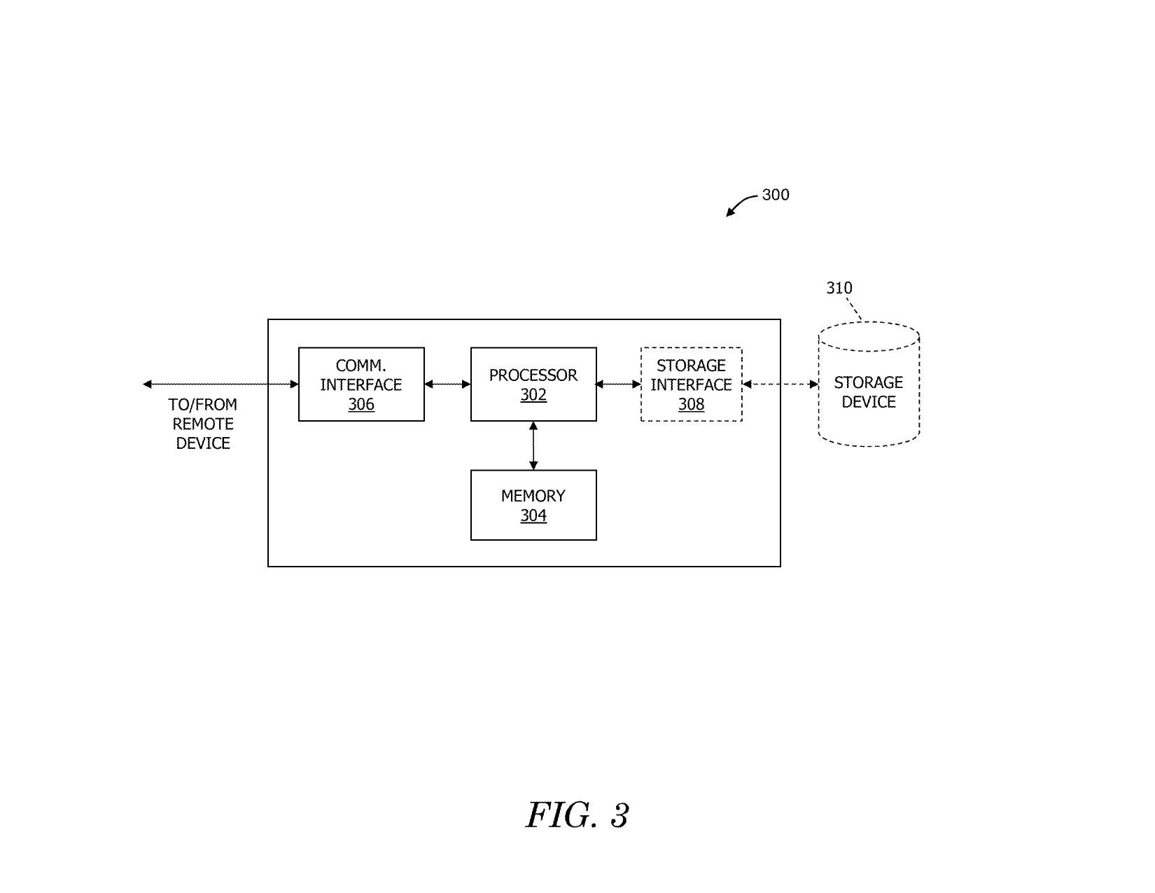

FIG. 3 is an example configuration of a server system 300, such as the server system 30 (shown in FIG. 1). The server system 300 includes, but is not limited to, the database 26 (shown in FIG. 1).

In the example embodiment, the server system 300 includes a processor 302 for executing instructions and a memory 304. The instructions may be stored in the memory 304, for example. The processor 302 includes one or more processing units (e.g., in a multi-core configuration) for executing the instructions. The instructions may be executed within a variety of different operating systems on the server system 300, such as UNIX, LINUX, Microsoft Windows®, etc. More specifically, the instructions may cause various data manipulations on data stored in a storage device 310 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.).

The processor 302 is operatively coupled to a communication interface 306 such that the server system 300 can communicate with remote computing devices, such as a computing system 200 (shown in FIG. 2) or another server system. For example, the communication interface 306 may receive communications from the electric vehicle 24 or a user system 32 via the network 20 (shown in FIG. 1), such as the Internet.

The processor 302 is operatively coupled to the storage device 310. The storage device 310 is any computer-operated hardware suitable for storing and/or retrieving data. In some embodiments, the storage device 310 is integrated in the server system 300. In other embodiments, the storage device 310 is external to the server system 300 and is similar to the database 26. For example, the server system 300 may include one or more hard disk drives as the storage device 310. In other embodiments, the storage device 310 is external to the server system 300 and may be accessed by a plurality of server systems 300. For example, the storage device 310 may include multiple storage units such as hard disks or solid-state disks in a redundant array of inexpensive disks (RAID) configuration. The storage device 310 may include a storage area network (SAN) and/or a network attached storage (NAS) system.

In some embodiments, the processor 302 is operatively coupled to the storage device 310 via a storage interface 308. The storage interface 308 is any component capable of providing the processor 302 with access to the storage device 310. The storage interface 308 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 302 with access to the storage device 310.

The memory area 304 includes, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

### COMPUTER-IMPLEMENTED METHODS

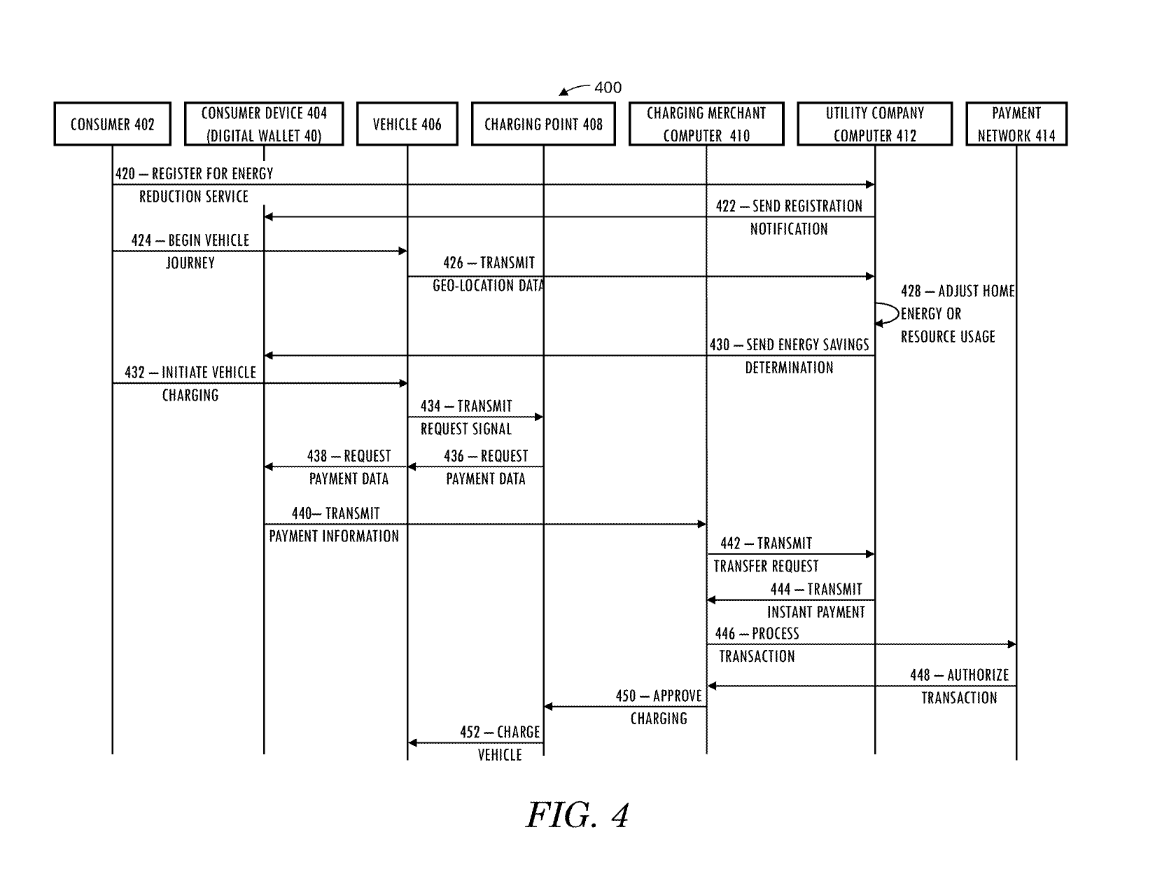

FIG. 4 is a process flow diagram for a process 400 for an electrical energy-based transaction between a consumer 402, which can include the consumer 22 (shown in FIG. 1), and a charging supplier merchant, such as the merchant 12 (shown in FIG. 1), in accordance with an aspect of the present disclosure. The process 400 is described below, for ease of reference, as being executed by exemplary devices and components introduced with the embodiments illustrated in FIGS. 1-3. In one embodiment, the process 400 may be implemented by the system 10 (shown in FIG. 1). The process 400 may be implemented on other computing devices and/or systems through the utilization of processors, transceivers, hardware, software, firmware, or combinations thereof. A person having ordinary skill will further appreciate that responsibility for all or some of the actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the operations outlined herein. The program(s) stored on the computer-readable medium(s) may instruct the processor or processing units to perform additional, fewer, or alternative actions, including those discussed elsewhere herein.

In the example, the consumer 402 has a property, such as the property 38 (shown in FIG. 1). A utility company, which may be the utility company 28 (shown in FIG. 1), provides utility services, such as electrical power, to the property 38. In an embodiment, the property consumes electrical power provided by the utility company. A utility company computing device 412 monitors the usage of the utility services, such as electrical power, by the property 38, such as a consumption rate, total usage, and the like. For example, the utility company may provide electric power to the property 38 through an electrical metering device (not shown) or gas services through a gas metering device (not shown). In an embodiment where the utility company provide electrical power, the utility company computing device 412 may measure voltage and current (e.g., kilowatt hours) associated with electrical power consumed by the property 38. In one example, a power monitoring device (not shown) may be integrated into the metering device. In some embodiments, any number of power monitoring devices may be integrated into a breaker/distribution box (not shown), such that measurements may be associated with individual circuits within the property 38. In yet another embodiment, a power monitoring device may be a smart plug and/or smart switch, configured to generate measurements associated with a specific consumer appliance or system, such as a heating, ventilation, and air conditioning (HVAC) system. Further, in some embodiments, gas and/or water lines of the property 38 may be arranged in circuits such that individual circuits may be controllable for supplying or restricting the utility services.

As shown in FIG. 4 at 420, the consumer 402 registers for an energy or resource reduction service with the utility company computing device 412, where the consumer 402 receives a monetary value associated with an energy or resource savings amount. The energy saving amount may be credited, for example, as a stored value amount or account credit that can be used during a vehicle charging transaction. For example, the utility company computing device 412 may facilitate the registration process by receiving or capturing consumer details and verifying consumer identity. The consumer details may be securely transmitted to the utility company computing device 412 by the consumer 402 using a consumer device 404, which may be the user system 32 (shown in FIG. 1). The stored value amount or credit may be dynamically updated based on energy-saving actions implemented by the utility company computing device 412 in association with the property 38. The stored value amount or credit can be stored in a secure digital wallet application, such as the digital wallet 40 (shown in FIG. 1), on the consumer device 404.

At 422, the utility company computing device 412 sends a notification of registration to the consumer 402 and, more particularly, to the consumer device 404. The utility company computing device 412 also sends information to the consumer device 404 on how to use the energy or resource savings amount for reducing the cost of vehicle charging to the consumer 402. The energy or resource savings amount may include, for example, a coupon that can be scanned at a physical charging location, a code that can be entered into a charging point 408 or included with payment information, an instant funds transfer to the charging supplier merchant, etc. The notification may include, for example, a unique identifier for the consumer 402 and detailed instructions on redeeming the energy or resource savings amount. In an embodiment, the communication may be encrypted to ensure security and may be transmitted via multiple channels such as email, SMS, push notification, a dedicated mobile application, and the like.

At 424, the consumer 402 begins a journey in his or her vehicle, such as the vehicle 406. The vehicle 406 may be equipped with a GPS module that continuously tracks a location of the vehicle 406. A computing device onboard the vehicle 406, which may include the consumer device 404, may monitor a battery level of the vehicle batteries (not shown) and notify the consumer 402 when it is time to charge the vehicle 406.

At 426, geo-location data of the vehicle 406, showing that the vehicle 406 is away from the consumer’s home, such as the property 38, is transmitted from the vehicle 406, or the consumer device 404, to the utility company computing device 412. The geo-location data may be transmitted in real-time and may include additional information such as the vehicle’s speed, direction, estimated time of arrival at a charging point 408, etc. The utility company computing device 412 may use the geo-location data to optimize energy or resource savings adjustments in the property 38.

At 428 the utility company computing device 412 alters the home energy or resource usage, such as the HVAC system or gas system in the consumer’s home (e.g., the property 38) for energy or resource savings. For example, in an embodiment, based on the geo-location data indicating that the consumer 402 is away from the property 38, the utility company computing device 412 may increase a temperature setting of the HVAC system on warm weather days to reduce energy usage, or reduce a temperature setting of the HVAC system on cool weather days to reduce energy usage. The utility company computing device 412 may communicate with and control a smart thermostat or home automation system to make these HVAC system adjustments, which may facilitate reducing an amount of electricity and/or gas used by the property 38. The adjustments may be made gradually to facilitate comfort and may be reversed when the geo-location data indicates that the vehicle 406 and/or the consumer 402 returns to the property 38. In an embodiment, the consumer 402, or other individuals, may override the adjustments made by the utility company computing device 412, for example, via the consumer device 404 or via the smart thermostat or home automation system at the property 38. For example, the geo-location data may indicate that the consumer 402 is away from the property 38, but one or more other individuals may be at the property 38. In such an instance, the adjustments made by the utility company computing device 412 may be overridden.

In an embodiment, the utility company computing device 412 may also be configured to monitor an alarm system at the property 38. When the geo-location data indicates that the consumer 402 is away from the property 38, and the alarm system is armed, the utility company computing device 412 may automatically alter the HVAC system in the consumer’s home. In another embodiment, before the utility company computing device 412 alters the HVAC system in the consumer’s home, the utility company computing device 412 may transmit a confirmation request to the consumer device 404 and receive a confirmation message from the consumer device 404 confirming that the consumer 402 is away from the property 38.

At 430, the utility company computing device 412 determines an energy or resource savings amount based on the HVAC system adjustment and notifies the consumer 402 with information on the energy or resource savings amount. The energy or resource savings amount may be calculated and/or updated based on real-time data from the property 38 and/or historical energy usage patterns for the property 38. The notification provided by the utility company computing device 412 may include a detailed breakdown of the cost savings and may be sent via the same channels used for the initial registration notification discussed above. As discussed above, the energy saving amount may be credited, for example, as a stored value amount or account credit that can be used during a vehicle charging transaction. The stored value amount or credit can be transmitted to, along with the notification, and stored in the secure digital wallet application, such as the digital wallet 40 (shown in FIG. 1), on the consumer device 404.

As further shown in FIG. 4 at 432, the consumer 402 initiates car charging when proximate the charging point 408 (such as one of the CPs 34 and 36). As previously noted, the charging point 408 can be a mobile charging vehicle (e.g., CP 36) or a fixed charging point (e.g., CP 34). The consumer device 404, whether a user’s mobile device or an onboard computer of the vehicle 406, may automatically detect nearby charging points 408 and present charging options to the consumer 402. The consumer 402 may select one or more charging options based on a variety of factors, such as time, cost, availability, and the like.

At 434, the vehicle 406 transmits a request signal to the charging point 408. For example, the consumer device 404 (or vehicle 406) may establish an API connection with the charging point 408 via a communications interface (e.g. communication interface 210 shown in FIG. 2) of the consumer device 404. The request signal may include the vehicle identification number (VIN), a battery status, and an amount of energy required or requested. The request signal may be transmitted over a secure communication channel to ensure the integrity and confidentiality of the data.

After communication is established, at 436, the charging point 408 prompts the consumer 402 for payment data, including transmitting transaction details and energy cost, etc. to the consumer device 404. The transaction details may include a total cost, an amount of energy to be delivered, and any applicable discounts or credits available to the consumer 402. The consumer 402 may be prompted to confirm the transaction via a mobile application or an in-vehicle interface.

At 438 the transaction details are received by the vehicle 406 and/or consumer device 404 and transmitted to the consumer device 404, such as to the digital wallet 40 (shown in FIG. 1). The digital wallet 40 may store the transaction details securely and may provide the consumer 402 with a summary of the transaction. The digital wallet 40 may also integrate with the consumer’s bank or payment provider to facilitate the payment process.

At 440, the consumer 402 may transmit payment information to a charging supplier merchant computing device 410. The payment information may be transmitted directly to the charging supplier merchant computing device 410 or, alternatively, to the charging supplier merchant computing device 410 via the charging point 408. The payment information may include a selection of utility energy or resource savings usage to decrease or cover the cost of the electrical charging. For example, the consumer 402 may submit a coupon via a digital code, request a real-time savings instant transfer to the charging supplier merchant computing device 410, etc. The digital wallet 40 may automatically apply any available energy credits or discounts to the transaction. The payment information may be transmitted securely to the charging supplier merchant computing device 410 to complete the transaction. In an embodiment, the payment information may include a primary account number (PAN), an expiration date, and a card security code, associated with the consumer’s payment card account 42. The payment card account information may also include consumer information such as a name, address, phone number, and/or other consumer information.

Optionally, if the consumer 402 submits a request for the real-time savings instant transfer payment option, the charging supplier merchant computing device 410 transmits the real-time savings instant transfer request and transaction information to the utility company computing device 412 at 442. The utility company computing device 412 may use this information to update the consumer’s energy or resource savings balance and may provide a confirmation or authorization request to the consumer 402. The transaction information may be stored in a database of the utility company computing device 412 for future reference.

In response to the request and transaction information received from the charging supplier merchant computing device 410, at 444, the utility company computing device 412 determines a monetary amount to be paid to the charging supplier merchant by the utility company to offset the transaction amount paid by the consumer 402 for the vehicle charge transaction. This monetary amount is determined based on the dynamic adjustment of the consumer’s HVAC system controls, as described above. The utility company computing device 412 may use advanced algorithms to calculate the optimal adjustments to the consumer’s HVAC system controls to maximize energy or resource savings. The adjustments may be made in real-time and may be based on factors such as the current weather, the consumer’s energy usage patterns, and the availability of renewable energy sources.

After receiving the payment information from the consumer 402, and optionally, the real-time savings instant transfer amount from the utility company computing device 412, the charging supplier merchant computing device 410 sends an authorization request to the payment network 414 at 446. The authorization request may include the payment information received from the consumer and a payment amount due for the charging transaction. In an embodiment, a server of the payment network, such as the server system 30 (shown in FIG. 1), may generate transaction information based on the authorization request and transmit the transaction information to an issuer associated with the consumer’s payment information, such as the issuer 18. The issuer 18 may process the transaction information to pre-authorize the payment amount included in the transaction information. The issuer 18 may parse the transaction information to identify a PAN associated with the payment account of the consumer 402. The issuer 18 subsequently may determine whether the payment account 42 includes sufficient available funds for processing the transaction. If the payment account 42 includes sufficient funds to complete the transaction, the issuer 18 may determine that pre-authorization is successful and may send a pre-authorization success message to the server system 30. Otherwise, the issuer 18 may determine that the pre-authorization has failed and may send a pre-authorization failure message to the server system 30.

At 448, upon receiving the pre-authorization success message, the server system 30 may send a message to the charging supplier merchant computing device 410 (via the acquirer 14 in some embodiments) indicating that the pre-authorization was successful. Upon receiving the pre-authorization failure message, the server system 30 may send a failure message to the user system 32 indicating that the pre-authorization was not successful. Upon receiving the failure message, the consumer 402 may select a different payment method stored in the digital wallet 40 and re-submit the transaction information, including information identifying the different payment method, otherwise the transaction is declined.

If the message received by the charging supplier merchant computing device 410 indicates that pre-authorization was successful, at 450 the charging supplier merchant computing device 410 approves vehicle charging and sends an instruction to the charging point 408 to begin charging the consumer vehicle 406. The approval may be based on the successful completion of the payment transaction and the availability of charging capacity. The charging supplier merchant computing device 410 may provide a confirmation to the consumer 402.

At 452, the charging point 408 initiates the charging process of vehicle 406. The charging process may be monitored by the vehicle’s onboard computer and the charging point’s system. The consumer 402 may be notified of the charging status and the estimated time to complete the charging. In some embodiments, the charging point 408 may also provide additional services such as battery health diagnostics and maintenance recommendations. In some embodiments, after charging is complete, the charging point 408 transmits a report to the charging supplier merchant computing device 410 indicating a final amount to charge the payment account 42 of the consumer 402.

Although FIG. 4 shows example steps of process 400, in some implementations, process 400 may include additional steps, fewer steps, different steps, or differently arranged steps than those depicted in FIG. 4. Additionally or alternatively, two or more of the steps of process 400 may be performed in parallel. For example, the geo-location data transmission and HVAC system control adjustments may be performed substantially simultaneously to optimize energy or resource savings. The process 400 may also be customized based on the consumer’s preferences and the specific capabilities of the devices involved.

### ADDITIONAL CONSIDERATIONS

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

The detailed description is to be construed as exemplary only and does not describe every possible embodiment because describing every possible embodiment would be impractical. Numerous alternative embodiments may be implemented, using either current technology or technology developed after the filing date of this application, which would still fall within the scope of the invention.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

As used herein, the term “database” includes either a body of data, a relational database management system (RDBMS), or both. As used herein, a database includes, for example, and without limitation, a collection of data including hierarchical databases, relational databases, flat file databases, object-relational databases, object-oriented databases, and any other structured collection of records or data that is stored in a computer system. Examples of RDBMS’s include, for example, and without limitation, Oracle® Database (Oracle is a registered trademark of Oracle Corporation, Redwood Shores, Calif.), MySQL, IBM® DB2 (IBM is a registered trademark of International Business Machines Corporation, Armonk, N.Y.), Microsoft® SQL Server (Microsoft is a registered trademark of Microsoft Corporation, Redmond, Wash.), Sybase® (Sybase is a registered trademark of Sybase, Dublin, Calif.), and PostgreSQL® (PostgreSQL is a registered trademark of PostgreSQL Community Association of Canada, Toronto, Canada). However, any database may be used that enables the systems and methods to operate as described herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor includes a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

What is claimed is:

1. A system comprising:
a utility company computing system comprising:
one or more processors, and
a memory including instructions that when executed by the one or more processors, cause the one or more processors to:
register a consumer for an energy or resource reduction service,
monitor electrical power usage at a property associated with the consumer,
adjust an HVAC system at the property based on geo-location data of the consumer,
determine an energy savings amount based on the adjustment to the HVAC system,
associate a monetary value with energy savings at the property, and
transmit the monetary value to a digital wallet application associated with the consumer.

2. The system in accordance with claim 1,
instructions further causing the one or more processors to:
receive, from a consumer device associated with the consumer, the geo-location data,
the HVAC system adjustment being made based on a location of the consumer relative to the property as indicated by the geo-location data.

3. The system in accordance with claim 1,
wherein monitoring the electrical power usage includes using an electrical metering device integrated with one or more power monitoring devices located at the property.

4. The system in accordance with claim 3,
the one or more power monitoring devices being integrated into a breaker/distribution box and being configured to measure energy consumption of individual circuits within the property.

5. The system in accordance with claim 3,
the one or more power monitoring devices comprising one or more of a smart plug and smart switch associated with one or more appliances or systems at the property.

6. The system in accordance with claim 1,
the HVAC system adjustment including one of the following: increasing a temperature setting of the HVAC system and reducing a temperature setting HVAC system, wherein such adjustment serves to reduce energy consumption while the consumer is away from the property.

7. The system in accordance with claim 1,
the instructions further causing the one or more processors to determine the monetary amount based on the energy savings resulting from the HVAC system adjustment at the property.

8. The system in accordance with claim 7,
the instructions further causing the one or more processors to update the monetary amount dynamically based on real-time data from the property and historical energy usage patterns.

9. The system in accordance with claim 1, further comprising:
a consumer device associated with the consumer, the consumer device comprising:
the digital wallet application;
one or more second processors; and
a second memory including second instructions, that when executed by the one or more second processors, cause the one or more second processors to:
receive a notification regarding the registration and energy savings amount,
store the monetary value in the digital wallet application, and
transmit payment information during a vehicle charging transaction.

10. The system in accordance with claim 9,
the second instructions further causing the one or more second processors to receive the notification via one or more of the following communication channels: email, smart message service (SMS), push notification, and a dedicated mobile application.

11. The system in accordance with claim 9,
the digital wallet application being configured to store transaction details for a vehicle charging transaction and to integrate with a bank or payment provider associated with the consumer to facilitate the vehicle charging transaction.

12. The system in accordance with claim 9,
the payment information comprising one or more of the following: a coupon, a digital code, and a request for real-time savings instant transfer.

13. The system in accordance with claim 9, further comprising a charging point configured to:
receive a vehicle charging request;
prompt the consumer for the payment information;
process the payment information, including applying the monetary value to the vehicle charging transaction; and
initiate charging of the vehicle based on the processing of the payment information.

14. A method performed by a computing system, the method comprising:
registering a consumer for an energy or resource reduction service;
monitoring electrical power usage at a property associated with the consumer;
adjusting an HVAC system at the property based on geo-location data of the consumer;
determining an energy savings amount based on the adjustment to the HVAC system;
associating a monetary value with energy savings at the property; and
transmitting the monetary value to a digital wallet application associated with the consumer.

15. The method in accordance with claim 14, further comprising:
receiving, from a consumer device associated with the consumer, the geo-location data,
the HVAC system adjustment being made based on a location of the consumer relative to the property as indicated by the geo-location data.

16. The method in accordance with claim 14,
monitoring the electrical power usage comprises using an electrical metering device integrated with one or more power monitoring devices located at the property.

17. The method in accordance with claim 16,
the one or more power monitoring devices being integrated into a breaker/distribution box and being configured to measure energy consumption of individual circuits within the property.

18. The method in accordance with claim 16,
the one or more power monitoring devices comprising one or more of a smart plug and smart switch associated with one or more appliances or systems at the property.

19. The method in accordance with claim 14,
the HVAC system adjustment including one of the following: increasing a temperature setting of the HVAC system and reducing a temperature setting HVAC system, wherein such adjustment serves to reduce energy consumption while the consumer is away from the property.

20. The method in accordance with claim 14, further comprising:
determining the monetary amount based on the energy savings resulting from the HVAC system adjustment at the property, and
updating the monetary amount dynamically based on real-time data from the property and historical energy usage patterns.
